(19) United States
(12) Patent Application Publication
(10) Pub. No.: US 2024/0279426 A1
(43) Pub. Date: Aug. 22, 2024

(54) NON-SILICONE THERMAL INTERFACE MATERIAL

(71) Applicant: Henkel AG & Co. KGaA, Duesseldorf (DE)

(72) Inventors: Yuqiang Qian, Falcon Heights, MN (US); Chunyong Wu, Plymouth, MN (US); John Timmerman, Minneapolis, MN (US); Reid John Chesterfield, Eden Prairie, MN (US)

(21) Appl. No.: 18/568,326

(22) PCT Filed: Jun. 2, 2022
(86) PCT No.: PCT/US2022/031889

§ 371 Date: Dec. 8, 2023

Related U.S. Application Data
(60) Provisional application No. 63/208,791, filed on Jun. 9, 2021.

(51) Int. Cl. C08K 3/04; C08K 3/22; H01M 10/653

(52) U.S. Cl. CPC C08K 3/04; H01M 10/653; C08K 2003/2227; C08K 2003/2296; C08K 2201/001; C08K 2201/005

(57) ABSTRACT

A thermally conductive composition includes a non-silicone polymer resin curable in place along a thermal dissipation pathway. The composition exhibits a low density for particular use in weight-sensitive applications that require a thermal conductivity of at least 1.5 W/m*K.

### FIELD OF THE INVENTION

The present invention relates to thermally conductive materials generally, and more particularly to thermal interface materials based on non-silicone polymers that are liquid dispensable and curable in situ into a relatively low density thermally conductive coating.

### BACKGROUND OF THE INVENTION

Thermally conductive materials are widely employed as interfaces between, for example, a heat-generating electronic component and a heat dissipater for permitting transfer of excess thermal energy from the electronic component to a thermally coupled heat dissipater. Numerous designs and materials for such thermal interfaces have been implemented, with the highest performance being achieved when gaps between the thermal interface and the respective heat transfer surfaces are substantially avoided to promote conductive heat transfer from the electronic component to the heat dissipater. The thermal interface materials therefore preferably mechanically conform to the somewhat uneven heat transfer surfaces of the respective components. Important physical characteristic of high-performance thermal interface materials are therefore flexibility and low hardness. In the case of dispensable materials, it is additionally important that the thermal interface is capable of wetting the heat transfer surface, and that it provides suitable adhesive and cohesive strength to avoid delamination and to maintain the form and function of the interface over the anticipated working lifetime. Dispensable thermal interface materials therefore may be designed with a yield stress to avoid significant spreading after dispensation, or without a yield stress to maximally flow and penetrate surfaces. Curing behavior of the material may also be tailored to both avoid particle settling and to provide sufficient pre-cure time for re-work and handling.

Electric vehicles (EV) rely on their onboard battery systems to operate. To satisfy customer needs, the battery systems installed in electric vehicles produce high power and are re-chargeable within short time periods. These characteristics require large current draws through the battery system, resulting in significant heat generation. As such, heat dissipation from the battery systems during charge and discharge cycles has become a critical aspect of battery system design. Thermal interface materials have been used to dissipate excess heat so as to maintain safe battery operating temperatures.

Increasing battery performance has driven higher thermal conductivity demands of thermal interface materials. Conventionally, thermal conductivity may be achieved with increased conductive filler loading. However, highly filled materials tend to exhibit high viscosity and resulting low dispensing speed, which limits production throughput. Moreover, highly filled materials exhibit increased densities due to the relatively high density of thermally conductive filler particles. Increased weight from the thermal interface material can reduce vehicle performance. Highly filled thermal materials also tend to exhibit significant abrasiveness, which can damage dispensing equipment.

Silicone oils and resins are widely used in thermal interface materials due to their low dispensing viscosity and high thermal stability. However, silicone oils tend to “bleed out” of the intended application location due to low surface tension and may therefore spread on the substrate and affect adjacent surfaces. An example is silicone thermal materials inhibiting the paintability of surfaces by undesirably spreading from their intended location. Moreover, most silicone resins contain volatile cyclic silicone oligomers that can affect the functions of other components such as optical sensors.

Some non-silicone materials have been proposed and implemented in thermal interface applications. It has been challenging, however, to design a non-silicone system that exhibits a suitable combination of temperature stability, pre-cure viscosity, and post-cure hardness. The development of silyl-modified polymers is promising for their desirable mechanical properties like low hardness, high use temperature, and versatility. Use of these and other non-silicone polymers in thermal interface applications have conventionally employed well-known thermally conductive particulate fillers such as aluminum nitride, silicon carbide, aluminum, alumina trihydrate, and boron nitride. Each of these filler materials suffer drawbacks including high cost, high abrasiveness, and poor hydrolytic stability that limit their use in certain applications.

It is therefore an undertaking of the present invention to provide a thermally conductive material that exhibits properties useful in weight-sensitive applications, including low density.

It is another undertaking of the present invention to provide a low-density thermally conductive material formed from a one or two-part composition deliverable through conventional dispensation equipment.

### SUMMARY OF THE INVENTION

By means of the present invention, a low density, high thermal conductivity material may be formed from a composition exhibiting a viscosity suitable for dispensation as a curable liquid coating through conventional liquid dispensing equipment. The composition realizes such attributes along with reduced abrasiveness in a non-silicone formulation. The composition generally includes three primary components: a non-silicone polymer resin, a diluent compatible with the non-silicone polymer resin, and a blended thermally conductive particulate filler. The pre-cured material exhibits a liquid dispensable viscosity and is curable to form a soft solid with high thermal conductivity. The specific blend of thermally conductive filler incorporating graphite particles permits the material to exhibit a density of less than 2.4 g/cm³.

In one embodiment, a thermally conductive composition includes a liquid diluent having a viscosity of less than 500 cP at 25° C., a silyl-modified non-silicone polymer resin that is soluble in the diluent, and particulate filler that includes 30-70 wt. % graphite particles having an average particle size of between 15 μm and 150 μm and balance wt. % non-graphite particles having an average particle size that is less than 33% of the graphite average particle size. The thermally conductive composition exhibits a density of less than 2.4 g/cm³ and a thermal conductivity of at least 1.5 W/m*K.

The silyl-modified non-silicone polymer resin may be condensation-curable, and the composition may include a catalyst that is effective to accelerate the condensation cure of the silyl-modified non-silicone polymer resin. The silyl-modified non-silicone polymer resin may include an alkoxy silane terminal group.

The composition may be curable at or above ambient temperature from a viscosity of less than 1000 Pa*s at 1s⁻¹ and 25° C. to a cured hardness of between 20 Shore 00 and 80 Shore A.

The graphite particles may be coated with pyrolized pitch carbon. The non-graphite particles may be selected from boron nitride, aluminum nitride, alumina, alumina trihydrate, aluminum, silicon carbide, silicon, silica, silicate, magnesium oxide, magnesium hydroxide, zinc oxide, and mixtures thereof. At least some of the non-graphite particles may be surface treated with alkyl compounds having between three and twelve carbon atoms.

The non-graphite particles may have an average particle size of less than 10 μm, wherein the particle sizes may be distributed in a multi-modal distribution with a first peak at between 0.1-1 μm and a second peak at between 1-10 μm.

A resin composition of a thermal interface may be formed from a two-part composition including a first part having a diluent with a viscosity of less than 500 cP at 25° C. and a non-silicone polymer resin that is soluble in the diluent, and a second part having water and a catalyst effective to accelerate a condensation cure reaction of the non-silicon polymer resin. At least one of the first and second parts includes graphite particles having an average particle size of between 15 μm and 150 μm and non-graphite particles having and average particle size of less than 10 μm. The two-part composition is curable upon mixing of the first and second parts at or above ambient temperature to the thermal interface with a hardness of between 20 Shore 00 and 80 Shore A, a thermal conductivity of at least 1.5 W/m*K, and a density of less than 2.4 g/cm³.

The non-silicone polymer resin may include an alkoxy-silane terminal group and may constitute between 10-35 wt. % of the composition.

The graphite particles and the non-graphite particles together define a particulate filler composition of which the graphite particles comprise between 30-70 wt. %.

The catalyst may include an organo-metallic compound, and a moisture scavenger may be included in the first part of the composition.

A battery system includes a battery and a thermally conductive composition thermally coupled to the battery. The thermally conductive composition includes a liquid diluent having a viscosity of less than 500 cP at 25° C., a silyl-modified non-silicone polymer resin that is soluble in the diluent, and particulate filler including 30-70 wt. % graphite particles having an average particle size of between 15 μm and 150 μm and balance wt. % non-graphite particles having an average particle size that is less than 33% of the graphite average particle size. The thermally conductive composition exhibits a density of less than 2.4 g/cm³ and a thermal conductivity of at least 1.5 W/m*K.

The thermally conductive composition may be cured to a hardness of between 20 Shore 00 and 80 Shore A and may exhibit a density of less than 2.2 g/cm³.

### DETAILED DESCRIPTION OF THE PREFERRED EMBODIMENTS

The objects and advantages enumerated above together with other objects, features, and advances represented by the present invention will now be presented in terms of detailed embodiments. Other embodiments and aspects of the invention, however, are recognized as being within the grasp of those having ordinary skill in the art.

The thermally conductive composition of the present invention may be formed as a coating on a surface or a self-supporting body for placement along a thermal dissipation pathway, typically to remove excess heat from a heat-generating electronic component, such as a battery system in an electric vehicle. The thermally conductive composition is preferably non-silicone and filled with thermally conductive particles to achieve a desired thermal conductivity, typically at least 1.5 W/m*K. The composition preferably exhibits sufficient flexibility and cohesive strength to provide a stable interface.

The thermally conductive composition is preferably dispensable through conventional liquid dispensing equipment, and thereafter cured to a soft solid. In some embodiments, the composition is initially separated into two or more parts and dispensable from at least two separate containers in order to separate the reactive silyl-modified polymer resin from a reaction catalyst and water until such time that the material is desired to be cured. The present composition is cured in situ after dispensation through silyl hydrolyzation and condensation. In other embodiments, the composition may be stored and dispensed from a single container, optionally in the presence of a reaction inhibitor or the absence of moisture to prevent premature cure of the silyl-modified polymer resin.

The composition contains a composite blend of thermally conductive filler that provides the thermally conductive material with a unique set of properties, including a density of less than 2.4 g/cm³. The relatively low density permits weight reduction in assemblies utilizing the thermal interface materials of the present invention.

### Resin

A variety of silyl-modified resins may be employed in the matrices of the present invention. Condensation-curable silyl-modified resins participate in a hydrolysis-condensation cure pathway, preferably at and above ambient temperatures. The resins are preferably non-silicone, wherein no more than a trace amount of silicone is contained in the composition. In some embodiments, no silicone is contained in the composition. In some embodiments the non-silicone resins are substantially free of —Si—O— units in the polymer therein. In other embodiments the non-silicone resins exclude polysiloxane resins and have no repeating—Si—O— units therein.

Silyl-modified reactive polymer resins employed herein are present in the range of about 5 up to about 50 percent by weight of the total composition; in some embodiments, the compositions comprise in the range of about 10 up to about 40 percent by weight of silyl-modified reactive polymer resin; in some embodiments, the compositions comprise in the range of 15 up to 35 percent by weight of silyl-modified reactive polymer resin; in some embodiments, the compositions comprise in the range of 18 up to 28 percent by weight of silyl-modified reactive polymer resins.

Example resins suitable for the reactive resins of the present invention include reactive polymer resins with at least one silyl-reactive functional group, including at least one bond that may be activated with water. Example silyl-reactive functional groups include alkoxy silane, acetoxy silane, and ketoxime silane.

The reactive polymer resin can be any non-silicone polymer capable of participating in a silyl hydrolyzation reaction. For example, the reactive polymer resin can be selected from a wide range of polymers as polymer systems that possess reactive silyl groups, for example a silyl-modified reactive polymer. The silyl-modified reactive polymers preferable have a non-silicone backbone to limit or avoid the release of silicone when heated, such as when used in an electronic device. Preferably, the silyl-modified reactive polymer has a flexible backbone for lower modulus and glass transition temperature. Preferably, the silyl-modified reactive polymer has a flexible backbone of polyether, polyester, polyurethane, polyacrylate, polyisoprene, polybutadiene, polystyrene-butadiene, polyisobutylene or polybutylene-isoprene.

The silyl-modified reactive polymer can be obtained by reacting a polymer with at least one ethylenically unsaturated silane in the presence of a radical starter, the ethylenically unsaturated silane carrying at least one hydrolyzable group on the silicon atom. For example, the silyl modified reactive polymer can be dimethoxysilane modified polymer, trimethoxysilane modified polymer, or triethoxysilane modified polymer. For example, the silyl modified reactive polymer may include a silane modified polyether, polyester, polyurethane, polyacrylate, polyisoprene, polybutadiene, polystyrene-butadiene, or polybutylene-isoprene.

The ethylenically unsaturated silane may be selected from the group made up of vinyltrimethoxysilane, vinyltriethoxysilane, vinyldimethoxymethylsilane, vinyldiethoxymethylsilane, trans-ß-methylacrylic acid trimethoxysilylmethyl ester, and trans-β-methylacrylic acid trimethoxysilylpropyl ester.

The silyl-modified reactive polymer preferably comprises(s) silyl groups having at least one hydrolyzable group on the silicon atom in a statistical distribution. For example, the silyl-modified reactive polymer can be a silane-modified polymer of general formula:

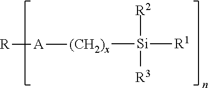

in which; R is a mono- to tetravalent polymer radical, R¹, R², R³ are each independently an alkyl or alkoxy group having 1 to 8 carbon atoms, and A represents a carboxy, carbamate, amide, carbonate, ureido, urethane, sulfonate group, oxygen atom or covalent bond, x=1 to 8 and n=1 to 4. In some embodiments R is free of —Si—O— units.

The silyl-modified reactive polymer can also be obtained by reacting a polymer with hydroxy group and alkoxysilane with isocyanate group. For example, the silyl modified reactive polymer can be dimethoxysilane modified polyurethane polymer, trimethoxysilane modified polyurethane polymer, or triethoxysilane modified polyurethane polymer. Further, the silyl-modified reactive polymer can be a α-ethoxysilane modified polymer of the average general formula:

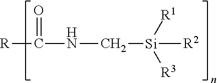

in which R is a mono- to tetravalent polymer residue, at most one third of the polymer of formula contained residues R¹, R² and R³ are independently alkyl radicals having 1 to 4 carbon atoms, at least one-quarter of the polymer of the formula residues contained R¹, R², and R³ are independently ethoxy residues that any remaining radicals R¹, R², and R³ independently of one another are methoxy radicals, and wherein n=1 to 4. In some embodiments R is free of —Si—O— units.

Silyl-modified reactive polymers are available, for example, as dimethoxysilane modified MS polymer with polyether backbone and XMAP™ polymer with polyacrylate backbone from Kaneka Belgium NV, trimethoxysilane modified ST polymer from Evonik, triethoxysilane modified Tegopac™ polymer from Evonik, silane modified Desmoseal™ polymer from Covestro, or di- or tri-methoxy silane modified Geniosil™ polymer from Wacker.

### Diluent

The present compositions preferably include a diluent to adjust the viscosity of the dispensable mass, particularly under shear, and to maintain a flexibility/softness property when the composition is in a cured state. The cured compositions exhibit a relatively low modulus or hardness of less than 80 Shore A to mitigate the stress in electronic component assembly and to promote conformability of the thermal material to respective contact surfaces of the electronic component.

Diluents useful in the present compositions are those which are effective in facilitating fluency of the coherent mass making up the composition. The diluents of the present invention are compatible with and preferably solvents for the selected non-silicone resins and may preferably be low-volatility liquids that reduce the viscosity of the overall pre-cured composition so that the composition is readably dispensable through liquid dispensing equipment. The diluent may therefore exhibit a viscosity of less than 500 cP at 25° C. In another embodiment, the diluent may exhibit a viscosity of less than 250 cP at 25° C. In a further embodiment, the diluent may exhibit a viscosity of less than 100 cP at 25° C. Preferably, the diluent exhibits a viscosity of between 1-50 cP at 25° C.

The diluent is preferably added to the composition in an amount suitable to appropriately adjust viscosity for pre-cured dispensability, and post-cured softness. In some embodiments, the diluent may represent about 1-50 percent by weight of the composition. In some embodiments, the diluent may represent about 1-20 percent by weight of the composition. In some embodiments, the diluent may represent about 5-10 percent by weight of the composition. The diluent may preferably be present at less than 20% by weight of the composition.

Example diluents include benzoates, oleates, ricinoleates, phthalates, trimellitates, teraphthalates, adipates, sebacastes, azelates, maleates, citrates, epoxidized vegetable oils, organosulfates, organophosphates, glycols and polyethers, ether esters, polyolefins, and combinations thereof.

### Thermally Conductive Particles

The selection of thermally conductive particulate filler is critical to achieving the desirable properties of the present invention, including low density, high thermal conductivity, low abrasiveness, high dispensability, form stability and cured flexibility. The Applicant has found that a blend of graphite and non-graphite particles, within critical ranges of average particle size, relative average particle size, and relative loading concentrations surprisingly achieves a highly thermally conductive composition that exhibits a density of less than 2.4 g/cm³. Compositions of the prior art require high loading concentrations of relatively dense thermally conductive particles, which results in overall material densities in excess of 2.4 g/cm³. It is theorized that the relatively large graphite particles reduce the abrasiveness of the dispensable composition while nevertheless maintaining a high degree of thermal conductivity.

The composition of thermally conductive filler included with the materials of the present invention includes both graphite and non-graphite particles. The filler composition contains between 30 wt. % and 70 wt. % of graphite particles; in some embodiments, the filler composition contains between 40 wt. % and 60 wt. % of graphite particles. The graphite particles preferably have an average particle size (d₅₀) of between 15 μm and 150 μm. The graphite particles may be selected from natural graphite, synthetic graphite, and graphite coated with pyrolyzed pitch carbon.

The balance wt. % (remainder) of the filler composition is non-graphite particles. Example non-graphite particles useful in the present invention include boron nitride, aluminum nitride, alumina, alumina trihydrate, aluminum, silicon carbide, silicon, silica, silicate, magnesium oxide, magnesium hydroxide, zinc oxide, and mixtures thereof. In some embodiments, the non-graphite particles may be surface treated with alkyl compounds having between three and twelve carbon atoms for compatibility with the polymer resin. Example surface treatment agents include alkoxy silane and fatty acid compounds.

The non-graphite particles preferably have an average particle size (d₅₀) of less than 33% of the graphite average particle size in the filler composition. In some embodiments the average particle size (d₅₀) of the non-graphite particles is less than 10 μm; in some embodiments, the average particle size (ds) of the non-graphite particles is less than 5 μm. The non-graphite particles may be present in a particle size distribution that is multi-modal. For the purposes hereof, the term “multi-modal” size distribution means a distribution with more than a single concentration peak (maximum) of particle sizes. In some embodiments, a bi-modal particle size distribution of non-graphite particles includes a first concentration peak at between 0.1 μm and 1 μm, and a second concentration peak at between 1 μm and 10 μm.

It is desirable that the compositions of the present invention exhibit a thermal conductivity of at least 1.5 W/m*K, more preferably at least 2 W/m*K, and still more preferably at least 2.5 W/m*K. The compositions of the present invention also preferably exhibit a density of less than 2.4 g/cm³, and more preferably less than 2.2 g/cm³.

The selection of graphite and non-graphite thermally conductive particles also defines the abrasiveness of the overall composition. The abrasiveness of the composition may be evaluated by a slurry abrasion test adapted from ASTM G75. It has been found that the compositions of the present invention incorporating the critical ranges of graphite and non-graphite particles exhibits a desirable low abrasiveness of less than 3 mg of aluminum metal loss per 6 hours of abrasion testing in the slurry test. This low abrasiveness preserves dispensing equipment over long use periods

### Reaction Catalyst

A reaction catalyst may be employed to further facilitate the hydrolyzation-condensation cure reaction of the silyl-modified reactive resin. Example reaction catalysts useful in the compositions of the present invention include organotin and organo-zinc and organo-titanium compounds (together referred to herein as “organo-metal catalyst”) that facilitate moisture cure of the silyl-modified reactive resins.

Reaction catalysts used in the compositions of the present invention are present in the range of about 0 up to about 1 percent by weight reaction catalyst. In some embodiments, the compositions comprise in the range of 0.1 up to about 0.5 percent by weight reaction catalyst. In some embodiments, the compositions comprise in the range of less than 0.5 percent by weight reaction catalyst, and more preferably less than 0.3 percent by weight reaction catalyst. For the purposes hereof, a concentration of “less than” a specified amount may include zero.

The thermally conductive compositions of the present invention are preferably curable in the presence of water (moisture curable) at or above ambient temperature. Depending upon the application, the moisture may be available from the ambient environment or from water supplied in the reactants. Preferably, the amount of water required in the composition itself is low so as not to interfere with functional properties of the thermal material. In some embodiments, water is present in the compositions of the invention in the range of 0 up to 2 percent by weight of the composition. In some embodiments, the compositions comprise in the range of 0.1 up to 1 percent by weight water. In some embodiments, the compositions comprise in the range of less than 2 percent by weight water, and more preferably less than 1 percent by weight water.

For the purposes hereof, the term “ambient temperature” is intended to mean the temperature of the environment within which the reaction occurs, and within a temperature range of 15-30° C., and preferably 25° C. The thermally conductive compositions are curable at ambient temperature within 72 hours, and preferably within 24 hours. The thermally conductive compositions may also be curable at elevated temperatures. For the purposes hereof, the term “curable” is intended to mean the composition can react under appropriate conditions and the reaction products will have an irreversible solid form.

### Water Scavenger

The compositions of the present invention preferably include a water scavenger to avoid reaction of the resin-containing component prior to dispensing so as to extend shelf life. The water scavenger may be, for example, alkyltrimethoxysilane, oxazolidines, zeolite powder, p-toluenesulfonyl isocyanate, oxocalcium, and ethyl orthoformate. The water scavenger is preferably vinyltrimethoxysilane. If too much of the water scavenger is included in the composition the curing will be slowed. The water scavenger may be present in an amount of greater than about 0.05 wt. % and less than about 5 wt. %, for example about 0.5 wt. % of the composition.

### Optional Additives

In accordance with some embodiments of the present invention, the compositions described herein may further comprise one or more additives selected from fillers, stabilizers, anti-oxidants, adhesion promoters, solvents, pigments, wetting agents, dispersants, flame retardants, extenders, and corrosion inhibitors. In other embodiments the compositions may be free of any or all of the additives.

### Properties

The curable compositions of the present invention are preferably curable at and above ambient temperatures, such as at and above 25° C. The curable compositions preferably exhibit a viscosity of less than 1000 Pa*s as measured on a parallel plate rheometer at 25° C. at a shear rate of 1s⁻¹, and more preferably less than 500 Pa*s at 25° C. at a shear rate of 1s⁻¹. The curable compositions preferably exhibit a dispensing rate of at least 100 g/min through a 3.175 mm orifice under 90 psi pressure at 25° C., and more preferably at least 200 g/min. After cure of the polymer resin, the compositions preferably exhibit a hardness of between 20 Shore 00 and 80 Shore A as measured by a durometer at 25° C.

### EXAMPLES

The Examples described herein provide exemplary compositions which are not intended to be limiting to the various compositions contemplated by the present invention.

### Example 1

Compositions 1-1 to 1-6 in Tables 1a and 1b below represent example single-component formulations

TABLE 1a

| | EX 1-1 | EX 1-2 | EX 1-3 | EX 1-4 | EX 1-5 | EX 1-6 |
|---|---|---|---|---|---|---|
| List of Constituents | phr | phr | phr | phr | phr | phr |
| diluent | 71 | 71 | 71 | 71 | 71 | 71 |
| antioxidant | 1 | 1 | 1 | 1 | 1 | 1 |
| dispersing agent | 1.6 | 1.6 | 1.6 | 1.6 | 1.6 | 1.6 |
| catalyst | 0.4 | 0.4 | 0.4 | 0.4 | 0.4 | 0.4 |
| SMP1 | 20 | 20 | 20 | 20 | 20 | 20 |
| SMP2 | 5 | 5 | 5 | 5 | 5 | 5 |
| Moisture Scavenger | 1 | 1 | 1 | 1 | 1 | 1 |
| Fumed silica | 1 | 1 | | 2 | | |
| Graphite 1, d₅₀ = 20-25 μm | 170 | 170 | 190 | | 170 | 170 |
| Graphite 2, d₅₀ = 40-50 μm | | | | 190 | | |
| Alumina 1, mono-modal d₅₀ = 2-5 μm | 170 | | | | | |
| Alumina 2, bi-modal d₅₀ = 1-5 μm | | 170 | 190 | 190 | 100 | |
| Zinc oxide, d₅₀ = 0.1-2 μm | | | | | 50 | |
| Aluminum Nitride, mono-modal d₅₀ = | | | | | | 90 |
| 1.5-5 μm | | | | | | |
| Alumina 3, mono-modal d₅₀ = | | | | | | 40 |
| 0.1-1 μm | | | | | | |
| Total | 441 | 441 | 480 | 482 | 420 | 400 |

TABLE 1b

| | EX 1-1 | EX 1-2 | EX 1-3 | EX 1-4 | EX 1-5 | EX 1-6 |
|---|---|---|---|---|---|---|
| Density, g/cm³ | 1.96 | 1.96 | 2.02 | 2.02 | 1.95 | 1.83 |
| Dispensing rate, g/min, 90 psi, | 623 | 775 | 306 | 1203 | 579 | 239 |
| 3.175 mm orifice | | | | | | |
| Viscosity, Pa*s, 1 s−1 @25° C. | 151 | 290 | 437 | 263 | 430 | 449 |
| Thermal conductivity, W/m*K, | NA | 2.61 | 3.25 | 2.98 | 2.64 | 3.38 |
| ASTM D5470, cured to 6 mm | | | | | | |
| thickness | | | | | | |
| Hardness, cured (Shore 00) | 61 | 52 | 60 | 52 | 51 | 60 |

### Example 2

Compositions 2-1 and 2-2 in Table 2A below represent example two-component formulations, with the first part of each formulation designated as part “A”, and the second part of each formulation designated as part “B”.

TABLE 2A

| Part A | EX 2-1A | EX 2-2A |
|---|---|---|
| Composition | phr | phr |
| diluent | 94 | 94 |
| antioxidant | 2 | 2 |
| dispersing and rheology additive | 4 | 4 |
| catalyst | 0.43 | 0.43 |
| water | 3 | 3 |
| Graphite, d₅₀ = 20-25 μm | 176 | 176 |
| Alumina, bi-modal d₅₀ = 1-5 μm | 176 | 102 |
| Zinc oxide, d₅₀ = 0.1-2 μm | | 51 |
| Total | 455.43 | 432.43 |
| Density, g/cm³ | 1.96 | 1.94 |
| Viscosity, Pa*s, @ 25° C., 1s⁻¹ | 443 | 695 |
| Dispensing rate, g/min, 90 psi, | 890.2 | 801 |
| 3.175 mm orifice | | |
| Part B | EX 2-1B | EX 2-2B |
| Composition | phr | phr |
| diluent | 48 | 48 |
| SMP | 48 | 48 |
| Moisture scavenger | 3 | 3 |
| dispersing and rheology additive | 5 | 5 |
| Graphite, d₅₀ = 20-25 μm | 162 | 162 |
| Alumina, bi-modal d₅₀ = 1-5 μm | 162 | 95 |
| Zinc oxide, d₅₀ = 0.1-2 μm | | 47 |
| Total | 428 | 408 |
| Density, g/cm³ | 1.95 | 1.94 |
| Viscosity, Pa* s, @ 25° C., 1s⁻¹ | 623 | 733 |
| Dispensing rate, g/min, 90 psi, | 288.2 | 327.2 |
| 3.175 mm orifice | | |

Properties for the cured compositions of Example two following mixing of the respective parts A and B for each of compositions 2-1 and 2-1 are set forth in Table 2B below.

TABLE 2B

| | EX 2-1 | EX2-2 |
|---|---|---|
| Thermal conductivity, W/m*k, | 2.6 | 2.8 |
| ASTM D5470, cured to 6 mm | | |
| thickness | | |
| Hardness, cured (Shore 00) | 67 | 67 |

### Example 3

Compositions 3-1, 3-2, and 3-3 represent control formulations that do not possess the thermally conductive filler blends of the present invention. Although the control formulations demonstrate good thermal conductivity, their densities are unsuitable for the intended applications of the present invention.

TABLE 3

| | EX 3-1 | EX 3-2 | EX3-3 |
|---|---|---|---|
| Resin composition (phr) | 100 | 100 | 100 |
| Aluminum Hydroxide (phr) | | 467 | 510 |
| Alumina (phr) | 1050 | 155 | 205 |
| Zinc oxide (phr) | | 67 | |
| Total (phr) | 1150 | 789 | 815 |
| Thermal conductivity, W/m*K, | 3.2 | 2.2 | 2.4 |
| ASTM D5470 | | | |
| Density, g/cm³ | 3.12 | 2.3 | 2.5 |

### Example 4

Compositions 4-1 and 4-2 represent example formulations consistent with the present invention, while compositions 4-3, 4-4, and 4-5 represent prior art thermally conductive particle blends including relatively large non-graphite particle sizes. As shown in Table 4 below, compositions 4-1 and 4-2 exhibit significantly reduced abrasiveness as compared to compositions 4-3, 4-4, and 4-5. Abrasiveness was tested based on ASTM G75 in a Miller slurry abrasion tester. The material was diluted with equal volume of diluent (same oil was used for all compositions in this Example 4) to form a slurry. Aluminum wear blocks were used and the loss of metal was measured after 6 hours of abrasion.

TABLE 4

| | EX 4-1 | EX 4-2 | EX 4-3 | EX 4-4 | EX 4-5 |
|---|---|---|---|---|---|
| Resin composition (phr) | 100 | 100 | 100 | 100 | 100 |
| 40-60 μm graphite (phr) | 80 | | 80 | | |
| 40-60 μm alumina (phr) | | | | | 160 |
| 40-60 μm alumina | | | 96 | 135 | 300 |
| hydroxide (phr) | | | | | |
| 20-30 μm graphite (phr) | 80 | 176 | | 110 | |
| 2-5 μm alumina (phr) | 100 | 102 | 100 | 100 | 140 |
| 0.1-1 μm ZnO (phr) | 40 | 51 | 40 | 40 | 60 |
| loss of Al metal, mg. | <1 | <2 | 4 | 8 | 9 |

1. A thermally conductive composition, comprising:
a liquid diluent having a viscosity of less than 500 cP at 1s⁻¹ and 25° C.;
a silyl-modified non-silicone polymer resin soluble in the diluent;
particulate filler comprising:
(i) 30-70 wt. % graphite particles having an average particle size of between 15 μm and 150 μm; and
(ii) balance non-graphite particles having an average particle size that is less than 33% of the graphite average particle size,
wherein the thermally conductive composition exhibits a density of less than 2.4 g/cm³ and a thermal conductivity of at least 1.5 W/m*K.

2. The thermally conductive composition of claim 1, wherein the silyl modified non-silicone polymer is condensation-curable and optionally comprising a catalyst effective to accelerate condensation cure of the silyl-modified non-silicone polymer.

3. The thermally conductive composition of claim 1, wherein:
the silyl-modified non-silicone polymer includes an alkoxy silane terminal group; and/or
the silyl-modified non-silicone polymer is free of —Si—O— units; and/or
the silyl-modified non-silicone polymer is a two-part composition.

4. The thermally conductive composition of claim 1, wherein the composition is curable at 25° C. from a viscosity of less than 1000 Pa*s at 1s⁻¹ and 25° C. to a cured hardness of between 20 Shore 00 and 80 Shore A.

5. The thermally conductive composition of claim 1, wherein the graphite particles are coated with pyrolized pitch carbon.

6. The thermally conductive composition of claim 1, wherein the non-graphite particles are selected from boron nitride, aluminum nitride, alumina, alumina trihydrate, aluminum, silicon carbide, silicon, silica, silicate, magnesium oxide, magnesium hydroxide, zinc oxide, and mixtures thereof.

7. The thermally conductive composition of claim 1, wherein at least some of the non-graphite particles are surface treated with alkyl compounds having between three and twelve carbon atoms.

8. The thermally conductive composition of claim 1, wherein the non-graphite particles have an average particle size of less than 10 μm.

9. The thermally conductive composition of claim 1, wherein the non-graphite particles have a multi-modal particle size distribution.

10. The thermally conductive composition of claim 9, wherein the multi-modal particle size distribution includes a first peak at between 0.1 μm and 1 μm, and a second peak at between 1 μm and 10 μm.

11. Cured reaction products of the thermally conductive composition of claim 1.

12. A battery system, comprising:
a battery; and
the thermally conductive composition of claim 1 thermally coupled to the battery.

13. The battery system of claim 12, wherein the thermally conductive composition is cured to a hardness of between 20 Shore 00 and 80 Shore A.

14. The battery system of claim 12, wherein the thermally conductive composition exhibits a density of less than 2.2 g/cm³.

15. A thermal interface formed from a two-part composition comprising:
a first part including a diluent having a viscosity of less than 500 cP at 25° C. and a non-silicone polymer resin that is soluble in the diluent; and
a second part including water and a catalyst effective to accelerate a condensation cure reaction of the non-silicone polymer resin,
wherein at least one of the first and second parts includes graphite particles having an average particle size of between 15 μm and 150 μm and non-graphite particles having an average particle size of less than 10 μm, and wherein the two-part composition is curable upon mixing the first and second parts together at or above ambient temperature to form the thermal interface with a hardness of between 20 Shore 00 and 80 Shore A, a thermal conductivity of at least 1.5 W/m*K, and a density of less than 2.4 g/cm³.

16. The thermal interface of claim 15, wherein the non-silicone polymer is a silyl-modified polymer including an alkoxy silane terminal group.

17. The thermal interface of claim 15, wherein the diluent and the non-silicone polymer together define an organic resin composition wherein the non-silicone polymer comprises between 10-35 wt. % of the organic resin composition.

18. The thermal interface of claim 15, wherein the graphite particles and the non-graphite particles together define a particulate filler composition of which the graphite particles comprise between 30-70 wt. %.

19. The thermal interface of claim 15, wherein the catalyst includes an organo-metallic compound.

20. The thermal interface of claim 15, including a moisture scavenger in the first part.

21. (canceled)
